(19) United States
(12) Patent Application Publication
(10) Pub. No.: US 2010/0224223 A1
(43) Pub. Date: Sep. 9, 2010

(54) DISHWASHER WITH A DRIVE MOTOR FOR FILTER OR SPRAY ARM

(75) Inventors: Dennis L. KEHL, Benton Harbor, MI (US); Andreas MARETTEK, Sulzbach (DE)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, Benton Harbor, MI (US)

(21) Appl. No.: 12/398,206

(22) Filed: Mar. 5, 2009

(51) Int. Cl. B08B 3/04

(52) U.S. Cl. 134/56 D

(57) ABSTRACT

An automatic dishwasher having a rotationally coupled spray arm and filter, with a motor for effecting the relative rotation of the spray arm and filter, wherein one of the rotor and stator is formed by a portion of one of the spray arm assembly and the filter.

### BACKGROUND OF THE INVENTION

Contemporary dishwashers include a tub defining a wash chamber within which is provided a rack for holding dishes. A pump is provided for recirculating wash liquid throughout the tub to remove soils from the utensils. A rotating spray arm is typically positioned beneath the rack. The pump supplies liquid from a sump in the tub to the arm for spraying onto the adjacent rack, with the exiting liquid driving the rotation of the arm. The sprayed liquid returns by gravity to the sump for continued recirculation to define a liquid path. A filter is placed in the liquid path to filter or partially filter the liquid before it is circulated back to the wash chamber.

### SUMMARY OF THE INVENTION

The invention provides for an automatic dishwasher having a rotationally coupled spray arm and filter, with a motor for effecting the relative rotation of the spray arm and filter, one of the rotor and stator is formed by a portion of one of the spray arm assembly and the filter.

### BRIEF DESCRIPTION OF THE DRAWINGS

FIG. 1 illustrates a dishwasher suitable for use with the invention according to an embodiment of the invention.

FIG. 2 is a schematic of a dishwasher according to an embodiment of the invention.

FIG. 3 is a perspective view of a portion of the sump, spray arm assembly, and filter assembly according to an embodiment of the invention.

FIG. 4 is a perspective view of a portion of the sump, spray arm assembly, and filter assembly according to another embodiment of the invention.

FIG. 5 is a perspective view of a portion of the sump, spray arm assembly, and filter assembly according to another embodiment of the invention.

### DESCRIPTION OF EMBODIMENTS OF THE INVENTION

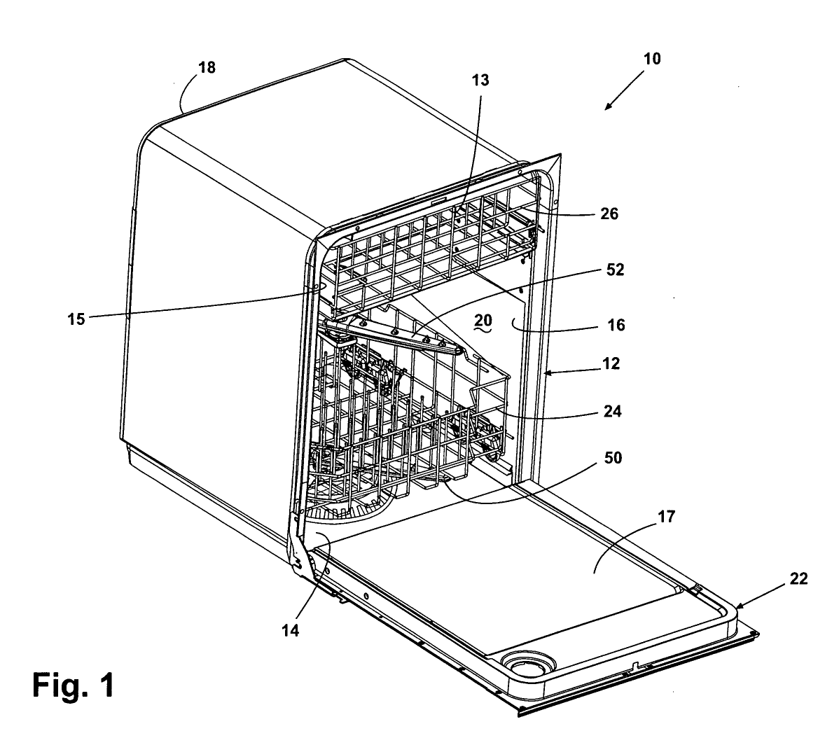

Referring now to the figures, FIG. 1 illustrates a dishwasher 10 according to one embodiment of the invention. The dishwasher 10 shares many features of a conventional automated dishwasher, which will not be described in detail herein except as necessary for a complete understanding of the invention. The dishwasher 10 includes a housing 12 having a top wall 13, bottom wall 14, two side walls 15, 16, a front wall 17, and a rear wall 18. The walls 13, 14, 15, 16 and 18 collectively define a treating chamber 20, which may be formed from a single piece referred to as a tub. The front wall 17 may be a door 22 of the dishwasher 10, which is moveable to selectively close and provide access to the treating chamber 20 for loading and unloading consumer articles such as utensils or other washable items. While the present invention is described in terms of a conventional dishwashing unit, it could also be implemented in other types of dishwashing units, such as in-sink dishwashers or drawer-type dishwashers.

Utensil holders in the form of a first rack or lower utensil rack 24 and a second or upper utensil rack 26 are located within the wash chamber 20 and receive utensils for washing. The lower and upper utensil racks 24, 26 are typically mounted for slidable movement in and out of the wash chamber 20 for ease of loading and unloading. For example, each of the lower and upper utensil racks 24, 26 is selectively moveable between a loading position where at least a portion of the lower and upper utensil racks 24, 26 extends exteriorly of the wash chamber 20 and a wash position where the lower and upper utensil racks 24, 26 are located entirely within the wash chamber 20.

As used in this description, the term utensil is generic to consumer articles such as dishes and the like that are washed in the dishwasher 10 and expressly includes, dishes, plates, bowls, silverware, glassware, stemware, pots, pans, and the like.

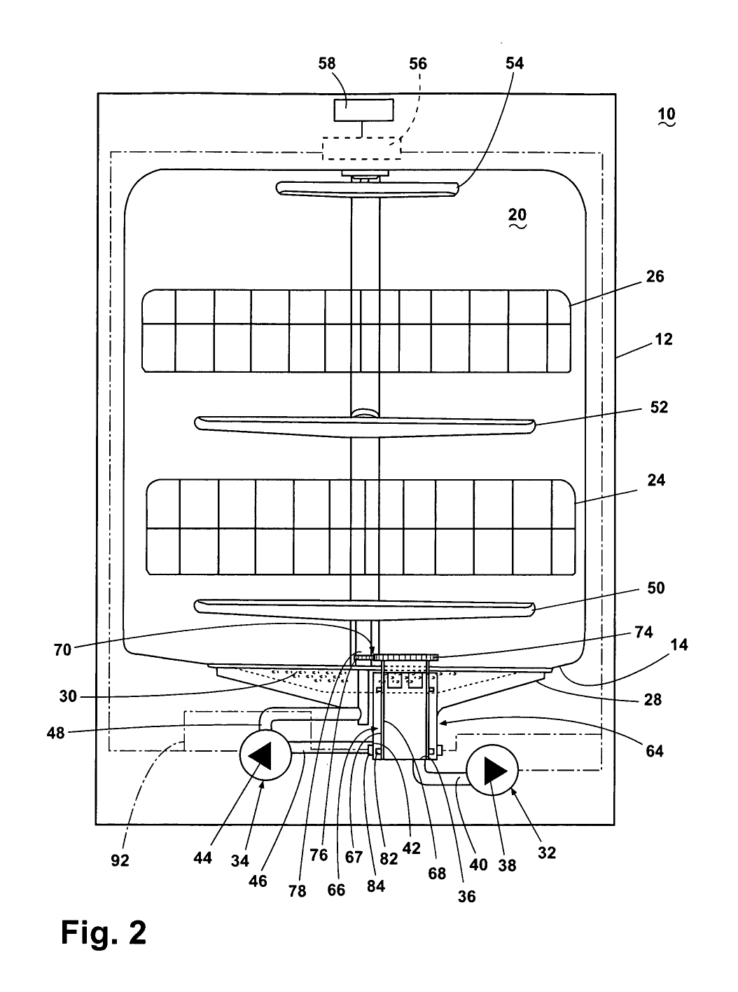

Referring to FIG. 2, the bottom wall 14 of the dishwasher 10 may be sloped to define a lower tub region or sump 28 that may be covered by a course screen filter or grating 30. The dishwasher 10 may further comprise a drain assembly 32 and a circulation assembly 34. The drain assembly 32 may be fluidly connected with the sump 28 to drain liquid and soil that collects in the sump 28 through one or more drain inlets 36 located in the lower portion of the sump 28. The drain assembly 32 may further comprise a drain pump 38 fluidly coupling the drain inlets 36 to a drain hose 40, which is fluidly coupled to a household drain (not shown). In this manner, the drain pump 38 may be actuated to draw liquid and soils from the sump 28 and direct them to the household drain.

The circulation assembly 34 may be fluidly coupled with the sump 28 and the wash chamber 20 to circulate liquid from the sump 28 to the wash chamber 20 through one or more circulation inlets 42 located at the bottom of the sump 28 (as illustrated) or near the lower portion of the sump 28. The circulation assembly 34 may further comprise a circulation pump 44 fluidly coupling with the circulation inlets 42 to circulate liquid from the sump 28 to the wash chamber 20. The circulation inlets 42 may be fluidly connected to the circulation pump 44 through a hose 46 or by other structures, such as a manifold assembly.

The circulation assembly 34 may also comprise a supply tube 48 first supply for delivering liquid to at least a rotating lower spray arm assembly 50. If the dishwasher 10 has a mid-level spray arm assembly 52 and/or an upper spray arm assembly 54, liquid may be selectively pumped through the supply tube 48 to each of the assemblies 50-54 for selective wash. In this way, the circulation assembly 34 can draw wash liquid collecting in the sump 28 and distribute it through the sprayers 50-54 into the wash chamber 20, where it naturally flows back to the sump 28 for recirculation or draining as the case may be.

The rotating lower spray arm assembly 50 is positioned beneath the lower utensil rack 24, the mid-level spray arm assembly 52 is positioned between the upper utensil rack 26 and the lower utensil rack 24, and the upper spray arm assembly 54 is positioned above the upper utensil rack 26. The rotating lower spray arm assembly 50 is configured to rotate in the wash chamber 20 and spray a flow of wash liquid from at least one outlet 48, in a generally upward direction, throughout a portion of the interior of the wash chamber 20. The spray from the rotating lower spray arm assembly 50 is typically directed to treat utensils located in the lower rack 24.

While the circulation assembly 34 is illustrated with three sprayers, it is within the scope of the invention for the circulation assembly 34 to comprise any number of sprayers. In addition, the circulation assembly 34 may also include one or more sprayers, jets or nozzles located anywhere within the wash chamber 20.

A controller 56 may be operably coupled to the circulation assembly 34, drain assembly 32, and various components of the dishwasher 10 to implement a cleaning cycle. The dishwasher 10 may be preprogrammed with a number of different cleaning cycles from which a user may select one cleaning cycle to clean a load of utensils. Examples of cleaning cycles include normal, light/china, heavy/pots and pans, and rinse only. A control panel or user interface 58 provided on the dishwasher 10 and coupled to the controller 56 may be used to select a cleaning cycle. The control panel 58 can be provided on the outer panel of the door 22 and can include operational controls such as dials, lights, switches, and displays enabling a user to input commands to the controller 56 and receive information about the selected cleaning cycle. Alternately, the cleaning cycle may be automatically selected by the controller 56 based on soil levels sensed by the dishwasher 10 to improve the cleaning performance of the dishwasher 10 for a particular load of utensils.

A filter assembly 64 comprising one or more cylindrical filter elements 66 may be disposed within the sump 28. The filter elements 66 separate the drain inlets 36 from the circulation inlets 42 such that liquid that enters the sump 28 may pass through the filter elements 66 before being recirculated.

A rotational motion coupler 70 that operably couples the lower spray arm assembly 50 and the filter assembly 64 such that rotation of the lower spray arm assembly 50 causes rotation of the filter assembly 64. Alternatively, rotation of the filter assembly 64 may cause rotation of the lower spray arm assembly 50.

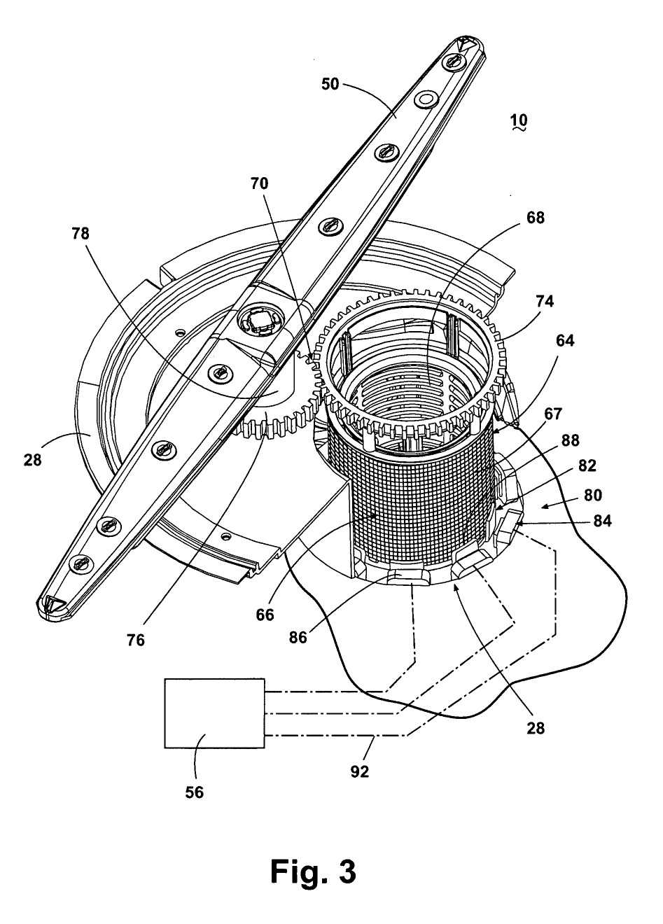

Referring to FIG. 3, the filter assembly 64 and rotational motion coupler will be described in greater detail. The filter element 66 is rotatably mounted in the dishwasher 10 and may comprise a filter housing 67 extending from the bottom of the sump 28 to the top and a filter screen 68 that may be removably received in the filter housing 67 much like a basket. The bottom of the filter housing 67 may be positioned at the bottom of the sump 28 such that little or no liquid can pass through the filter element 66 through any path other than through the filter housing 67 and filter screen 68 before being recirculated. The filter housing 67 may be made from any suitable material and have any suitable pore size. One example of a suitable material is stainless steel mesh screen.

The rotational motion coupler 70 includes a filter gear 74 operably coupled to the filter assembly 64 and a spray arm gear 76 operably coupled to a shaft 78 of the lower spray arm assembly 50. The filter gear 74 and the spray arm gear 76 interconnect with each other such that relative rotational movement may be transferred between the two. The filter gear 74 and the spray arm gear 76 have been illustrated as a spur gear assembly. However, the filter gear 74 and the spray arm gear 76 may be any suitable mechanism for translating the rotation of the filter assembly 64 to the lower spray arm assembly 50 and vice-versa. Alternative mechanisms may include bevel gears, crossed helical gears or a worm gear assembly where the second gear may actually be formed in the shaft 78 of the lower spray arm assembly 50.

A motor 80 motor is provided for effecting the relative rotation of the lower spray arm assembly 50 and filter assembly 64. The motor 80 includes a rotor 82 and a stator 84. The stator 84 is formed of stator magnets 86 integrated within the material forming the sump 28, which may be integrally formed in part of the tub, part of which is removed in FIG. 3 for clarity. The rotor 82 is illustrated as being a portion of the filter assembly 64. Specifically, the rotor 82 is formed of rotor magnets 88 spaced such that the filter assembly 64. The rotor magnets 88 are magnetically coupled to the stator magnets 86. The rotor magnets 88 may be configured to be mounted to the outside of a filter housing 90 of the filter assembly 64 or may be integrally formed within the filter housing 90.

For explanation purposes the rotor magnets 88 will be described as permanent magnets while the stator magnets 86 will be described as electromagnets. The stator magnets 86 receive electrical power through suitable power leads 92 coupling the stator magnets 86 with the controller 56. The controller 56 is also coupled electrically with a power supply (not shown). With this configuration, the controller 56 may be used to electrically commutate the motor and effect the rotation of the rotor 82. During operation of the dishwasher 10, the controller 56 may be employed to control the operation of the motor 80. A user may input commands on the control panel 58 for selecting operations such as a selected wash cycle, the temperature of the wash liquid, and the like.

The invention is not so limited and it should be recognized that the magnets could both be electromagnets or any other type of magnet configured to move the filter assembly 64. The invention is not so limited and it should be recognized that the magnets could both be electromagnets or any other type of magnet configured to move the filter assembly 64. To the extent that the rotor magnets 88 may also be electromagnets suitable power lines extending through a side wall 15 or the rear wall 10, the penetration through the side wall 15 or rear wall 18 can be configured with seals, boots, grommets, and the like for suitable water tightness.

The stator magnets 86 may be configured in a variety of configurations and may be configured to be in communication with and controlled by the controller 56 such that the speed of rotation of the motor 80 may vary based upon wash programs associated with the dishwasher 10. To operate the motor 80 electrical power is supplied by the controller 56 to the stator magnets 86. The permanent rotor magnets 88 are composed of two or more permanent magnet pole pieces. The stator 84 is composed of electromagnets that are connected to a power source through the controller 56. Electric current from the power source induces a magnetic field. The magnetic field produced by the current in the electromagnets interacts with the field of the permanent magnets of the rotor 82, causing the rotatable filter assembly 64 to turn.

In this illustration, the rotor 82 has five pole pairs that surround the entirety of the filter housing 90 (partially shown). The opposite polarities of the energized electromagnets of the stator 84 and the rotor magnets 88 attract. This results in the rotation of the filter assembly 64 until the rotor magnets 88 are aligned with the stator 84. Just as the rotor 82 reaches alignment, the stator magnets 86 are oppositely charged and the now opposite polarities of the energized electromagnets of the stator 84 and the rotor magnets 88 attract and the filter assembly 64 will again rotate until the stator magnets 86 are aligned with the stator 84. This process continues the entire time the motor 80 is operated.

Thus, when the motor 80 is operated, the motor 80 rotates the filter assembly 64. Because the filter assembly 64 is coupled to the lower spray arm assembly 50 by the rotational motion coupler 70, the rotation of the filter assembly 64 drives rotational movement of the lower spray arm assembly 50. The motor 80 can operate in both a forward and reverse direction. The rotational speed of the motor 80 and, thus, the rotation speed of the spray arm may be variably controlled. Thus, the motor 80 and the rotational motion coupler 70 provide for controlling the direction and speed of rotation of the spray arm assembly 50 is a practically unlimited manner. This functionality may be used to improve the cleaning of the utensils in the lower utensil rack 24. For example, the controller 56 may control the time the lower spray arm assembly 50 is operated in each direction. Further, the controller 56 may operate the motor 80 to slow or even stop the lower spray arm assembly 50. Slowing or stopping the rotation of the lower spray arm assembly 50 may provide better cleaning in certain areas of the wash chamber 20.

During the course of a wash or rinse cycle, liquid and soil drains towards the bottom 22 of the tub 12 and may enter the sump 28 through the grating 26. During this time, the controller 56 may also operate the circulation assembly 34 to deliver liquid to one or more of the spray arm assemblies 50-54. Liquid may be drawn into the circulation assembly 34 from the hose 46 through the circulation inlets 40. Soil may be drawn into the drain assembly 32 from the drain channels 64 through the drain inlets 34. As liquid entering the sump 28 is drawn into the filter assembly 64, soil present in the liquid that is larger than the pore size of the filter housing 67 and filter screen 68 is removed from the liquid. The movement of liquid and soil through the filter assembly 64 provides filtered water to the circulation assembly 34, which may supply filtered water to the spray arm assemblies 50-54 for spraying articles placed in the wash chamber 20.

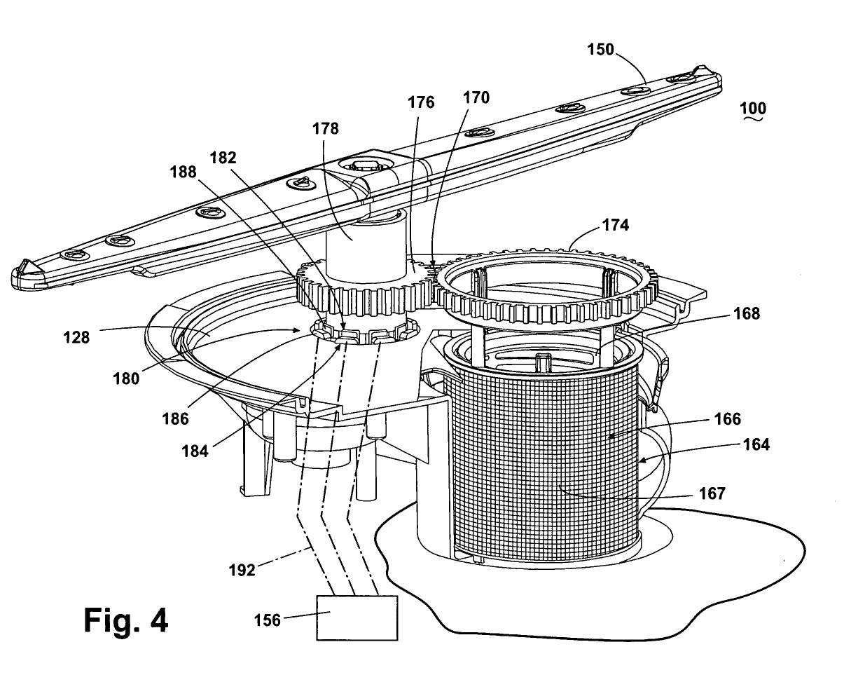

FIG. 4 is a perspective view of a dishwasher 100, lower spray arm assembly 150, filter assembly 164, and a motor 180 according to a second embodiment of the invention. The second embodiment 100 is similar to the first embodiment 10. Therefore, like parts will be identified with like numerals increased by 100, with it being understood that the description of the like parts of the first embodiment applies to the second embodiment, unless otherwise noted.

One difference between the first embodiment 10 and the second embodiment 100 is that the motor 180 includes a rotor 182 that is a portion of the lower spray arm assembly 150 and a stator 184 is formed of stator magnets 186 integrated within the material forming the sump 128 surrounding the shaft 178 of the lower spray arm assembly 150. Specifically, the rotor 182 is formed of rotor magnets 188 spaced such that the shaft 178 of the lower spray arm assembly 150 comprises the rotor 182. The rotor magnets 188 are coupled to the stator magnets 186 embedded into the sump 128. The rotor magnets 188 may be configured to be mounted to the outside of the shaft 178 or may be integrally formed within the shaft 178. The motor 180 may be controlled in a manner similar to the first embodiment. However, in this second embodiment, the motor 180 rotates the shaft 178, which rotates the lower spray arm assembly 150. Because the lower spray arm assembly 150 is coupled to the filter assembly 164 by the rotational motion coupler 170, the rotation of the lower spray arm assembly 150 also drives rotational movement of the filter assembly 164.

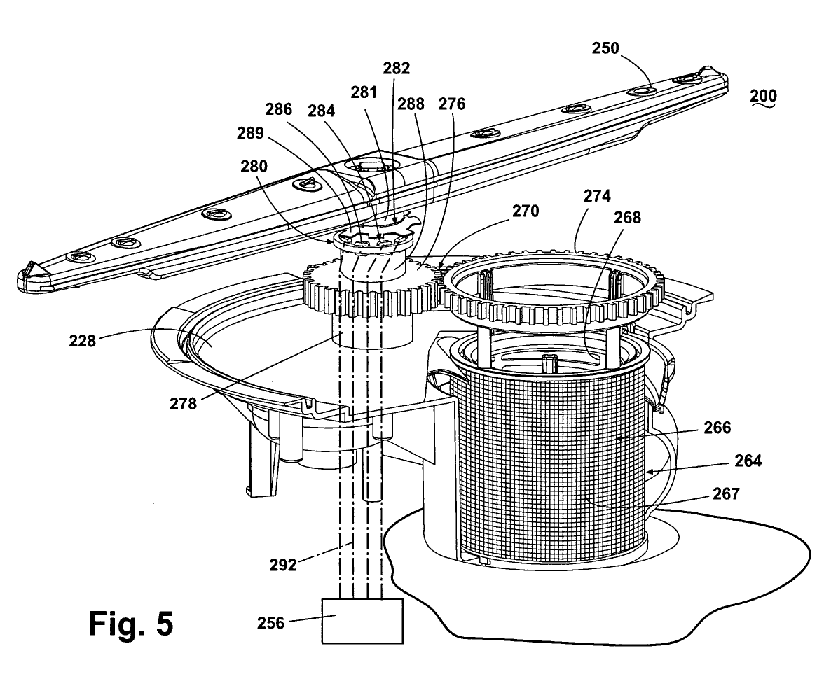

FIG. 5 is a perspective view of a dishwasher 200, lower spray arm assembly 250, filter assembly 264, and a motor 280 according to a third embodiment of the invention. The third embodiment 200 is similar to the second embodiment 100. Therefore, like parts will be identified with like numerals increased by 100, with it being understood that the description of the like parts of the second embodiment applies to the third embodiment, unless otherwise noted.

One difference between the second embodiment 100 and the third embodiment 200 is that the motor 280 includes a rotor 282 that includes a disc 288 attached to the shaft 278 of the lower spray arm assembly 250. The disc 288 has two or more permanent magnet pole pieces on at its outside edge. As illustrated, the disc 288 has a multitude of external points 289. These external points 289 each have a magnetic pole piece. The magnetic poles pieces alternate all the way around the disc 288.

Further, the stator 284 is formed of stator magnets 286 molded into a portion of the feed tube 281 for the lower spray arm assembly 250. The stator magnets 286 are electromagnets that receive electrical power through suitable power leads 292 coupling the stator magnets 286 with the controller 256. The controller 256 is also coupled electrically with a power supply (not shown). The interior of the feed tube 28 carries liquid to be sprayed to the lower spray arm assembly 250. The feed tube 281 is surrounded by the shaft 278 of the lower spray arm assembly 250. The motor 280 is controlled in a manner similar to the first and second embodiments. In the third embodiment, the motor 280 rotates the shaft 278 to rotate the lower spray arm assembly 250. Because the lower spray arm assembly 250 is coupled to the filter assembly 264 by the rotational motion coupler 270, the rotation of the shaft rotates the filter assembly 264.

While the invention has been described in connection with certain specific embodiments thereof, it may be understood that this is by way of illustration and not of limitation and the scope of the appended claims should be construed as broadly as the prior art will permit.

What is claimed is:

1. An automatic dishwasher for washing utensils with liquid in accordance with a cycle of operation, comprising:
a tub defining a wash chamber in which utensils are received for washing;
a spray arm assembly having a rotatable spray arm located in the wash chamber and through which liquid is sprayed into the wash chamber;
a filter assembly having a rotatable filter element located in the dishwasher and through which passes the liquid sprayed in the wash chamber during a recirculation or draining of the liquid;
a rotational motion coupler operably coupling the spray arm and the filter element such that rotation of one of the spray arm and filter element causes rotation of the other of the spray arm and filter element; and
a motor comprising a rotor and a stator, with one of the rotor and stator formed by a portion of one of the spray arm assembly and filter assembly wherein operation of the motor rotates at least one of the spray arm and the filter element.

2. The dishwasher of claim 1 wherein the rotor is at least partially formed by the filter element.

3. The dishwasher of claim 2 wherein the filter element comprises a rotatable housing with magnets forming the rotor.

4. The dishwasher of claim 3 wherein the magnets are integrated in the rotatable housing.

5. The dishwasher of claim 3 wherein the tub comprising a portion defining a recess with magnets to form the stator, with the recess being sized to receive at least the portion of the rotatable housing having the magnets.

6. The dishwasher of claim 3 wherein the rotatable housing further comprises a gear forming a portion of the rotational motion coupler.

7. The dishwasher of claim 6 wherein the spray arm assembly comprises a rotatable shaft on which the spray arm is mounted and further comprises a gear mounted to the shaft and which enmeshes with the gear of the rotatable housing.

8. The dishwasher of claim 3 wherein the rotatable housing comprises at least one screen filter through which the water passes.

9. The dishwasher of claim 1 wherein the spray arm assembly further comprises at least a portion of the rotor.

10. The dishwasher of claim 9 wherein the spray arm assembly comprises a shaft mounted to the spray arm and a magnet assembly mounted to the shaft to form the rotor.

11. The dishwasher of claim 10 wherein the spray arm assembly further comprises a housing receiving the shaft and a magnet assembly mounted to the housing to form the stator.

12. The dishwasher of claim 11 wherein the housing extends upwardly from the tub.

13. The dishwasher of claim 1, further comprising a sump formed in the lower portion of the tub, with the sump having magnets to form the stator.

14. The dishwasher of claim 13 wherein the filter element comprises a rotatable housing with magnets forming the rotor, with the portion of the filter element having the magnets being sized to be received within the sump.

15. An automatic dishwasher for washing utensils with liquid in accordance with a cycle of operation, comprising:
a tub defining a wash chamber in which utensils are received for washing;
a sump formed in the lower portion of the tub;
a spray arm assembly having a rotatable spray arm located in the wash chamber and through which liquid is sprayed into the wash chamber;
a filter assembly having a rotatable filter element located in the dishwasher and through which passes the liquid sprayed in the wash chamber during a recirculation or draining of the liquid;
a rotational motion coupler operably coupling the spray arm and the filter element such that rotation of one of the spray arm and filter element causes rotation of the other of the spray arm and filter element; and
a motor comprising a rotor and a stator, with an array of magnets provided in the sump to form the stator, and an array of magnets provided on one of a portion of one of the spray arm assembly and filter element to form the rotor, wherein operation of the motor rotates at least one of the spray arm and the filter element.

16. The dishwasher of claim 15 wherein the magnets provided in the sump are electromagnetic magnets that are operably coupled with a power source.

17. The dishwasher of claim 16 wherein the magnets provided in the sump are fluidly isolated from the wash chamber.

18. The dishwasher of claim 15 wherein the filter element comprises a rotatable housing with permanent magnets to form the rotor, with the portion of the filter element having the permanent magnets being sized to be received within the sump.

19. The dishwasher of claim 18 wherein the rotatable housing further comprises a gear forming a portion of the rotational motion coupler.

20. The dishwasher of claim 19 wherein the spray arm assembly comprises a rotatable shaft on which the spray arm is mounted and further comprises a gear mounted to the shaft and which enmeshes with the gear of the rotatable housing.

21. The dishwasher of claim 18 wherein the rotatable housing comprises at least one screen filter through which the water passes.

22. The dishwasher of claim 21 wherein the spray arm assembly comprises a shaft mounted to the spray arm and a magnet assembly mounted to the shaft to form the rotor.
